(19) United States
(12) Patent Application Publication
(10) Pub. No.: US 2014/0125670 A1
(43) Pub. Date: May 8, 2014

(54) METHOD FOR APPROXIMATING MOTION BLUR IN RENDERED FRAME FROM WITHIN GRAPHICS DRIVER

(71) Applicant: NVIDIA CORPORATION, Santa Clara, CA (US)

(72) Inventor: Scott Saulters, New Taipei City (TW)

(73) Assignee: NVIDIA CORPORATION, Santa Clara, CA (US)

(21) Appl. No.: 13/730,441

(22) Filed: Dec. 28, 2012

(30) Foreign Application Priority Data
Nov. 2, 2012 (TW) 101140927

(51) Int. Cl. G06T 15/80

(52) U.S. Cl. CPC G06T 15/80
USPC 345/426; 345/422

(57) ABSTRACT

The invention provides a method for approximating motion blur in rendered frame from within a graphics driver. For example, the method includes the steps of: (a) obtaining by the graphics driver values of a frame transformation matrix for a current rendered frame and a previous rendered frame respectively; (b) obtaining by the graphics driver depth values of the current rendered frame; and (c) loading by the graphics driver a shader onto a GPU, in order to enable the GPU to adjust color values of one or more sample areas on the current rendered frame, based on at least the values of the frame transformation matrix for the current rendered frame and the previous rendered frame and the depth values of the current rendered frame, whereby a motion blur effect is created in the current rendered frame.

### CROSS-REFERENCE TO RELATED APPLICATIONS

This application is based on and claims the benefit of priority from Taiwan Patent Application 101140927, filed on Nov. 2, 2012, which is herein incorporated by reference.

### BACKGROUND OF THE INVENTION

1. Field of the Invention

The present invention relates to a method for approximating motion blur in a rendered frame from within a graphics driver.

2. Description of the Related Art

Motion blur is a fundamental cue in the human's perception of objects in motion. Therefore it is a frequent requirement for computer-generated images where it needs to be explicitly simulated, in order to add to the realism.

For further details about the conventional arts, please refer to such as Fernando Navarro, Francisco J. Sern and Diego Guitierrez. Motion Blur Rendering: State of the Art. Computer Graphics Forum Volume 30 (2011), number 1, pp. 3-26. Also references could be made to U.S. Pat. No. 7,362,332, entitled “System and method of simulating motion blur efficiently”, which is owned by the applicant of the present invention.

### SUMMARY OF THE INVENTION

It is an aspect of the present invention to provide a method for approximating motion blur in a rendered frame from within a Graphics driver, and particularly, a method for post-processing a frame which has been rendered as desired by a graphics application, to create a motion blur effect.

In contrast, a motion blur was conventionally determined by the graphics application in advance, and then the graphic processing unit (GPU) rendered the frame(s) with a stimulated motion blur using the object-scene data supplied from the graphics application, while many graphics applications tended to provide a high quality video or animation using high frame rates, without disposing stimulated motion blur. However, in some circumstances, it is more visually pleasing to have motion blur with a low frame rate than a high frame rate without motion blur, because it is more similar to the real visual perception.

In the embodiments of the invention, the graphics driver can approximate a motion blur using the data available to it in an application agnostic manner, particularly when the graphics application does not determine any motion blur at all. Meanwhile, the graphics driver can lower the frame rate by inserting the sleep cycles into threads, to save the power consumption.

An embodiment according to the present invention provides a method for approximating motion blur in rendered frame from within a graphics driver. The method includes the steps of:

(a) obtaining by the graphics driver values of a frame transformation matrix for a current rendered frame and a previous rendered frame respectively;

(b) obtaining by the graphics driver depth values of the current rendered frame; and

(c) loading by the graphics driver a shader onto a GPU, in order to enable the GPU to adjust color values of one or more sample areas on the current rendered frame, based on at least the values of the frame transformation matrix for the current rendered frame and the previous rendered frame and the depth values of the current rendered frame, whereby a motion blur effect is created in the current rendered frame.

Another embodiment according to the present invention provides a computer system, which comprises:

a graphics processing unit; and

a central processing unit, which is electrically connected with the graphics processing unit to execute a graphics driver to perform the aforementioned method for driving the graphics processing unit.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a block diagram of a computer system according to an embodiment of the present invention;

FIG. 2 illustrates a flow diagram of a method for approximating motion blur in a rendered frame from within the Graphics driver according to an embodiment of the present invention;

FIG. 3 illustrates the motion blur effect created or approximated in the current rendered frame according to an embodiment of the present invention; and

FIG. 4 illustrates an auxiliary color buffer of an embodiment according to the present invention.

### DETAILED DESCRIPTION

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

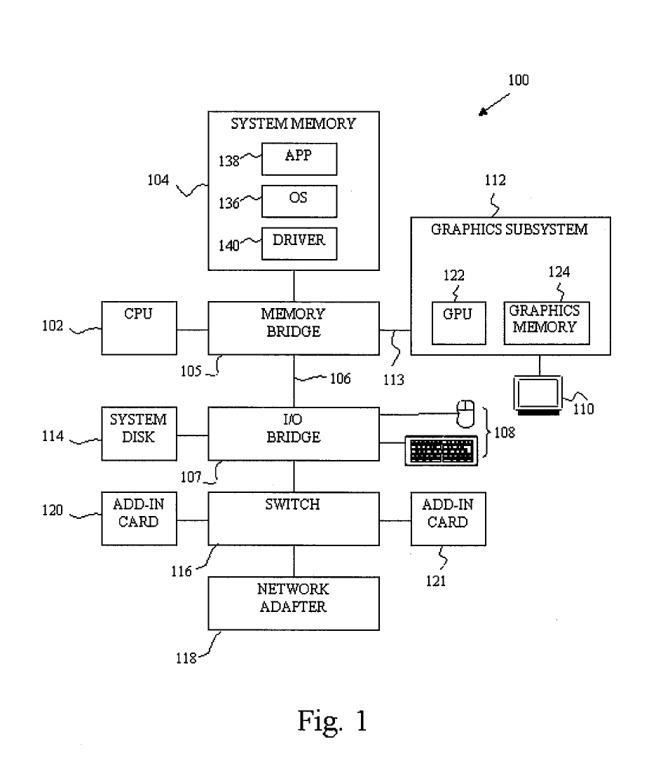

Referring now to FIG. 1 through FIG. 4, computer system, methods, and computer program products are illustrated as structural or functional block diagrams or process flowcharts according to various embodiments of the present invention. The flowchart and block diagrams in the Figures illustrate the architecture, functionality, and operation of possible implementations of computer system, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that embodiments can be practiced on many different types of computer system 100, as showed in FIG. 1. Examples include, but are not limited to, desktop computers, workstations, servers, media servers, laptops, gaming consoles, digital televisions, PVRs, and personal digital assistants (PDAs), as well as other electronic devices with computing and data storage capabilities, such as wireless telephones, media center computers, digital video recorders, digital cameras, and digital audio playback or recording devices.

### Computer System

FIG. 1 is a block diagram of a computer system 100 according to an embodiment of the present invention. Computer system 100 includes a central processing unit (CPU) 102. CPU 102 communicates with a system memory 104 via a bus path that includes a memory bridge 105. Memory bridge 105, which may be, e.g., a conventional Northbridge chip, is connected via a bus or other communication path 106 (e.g., a HyperTransport link) to an I/O (input/output) bridge 107. I/O bridge 107, which may be, e.g., a conventional Southbridge chip, receives user input from one or more user input devices 108 (e.g., keyboard, mouse) and forwards the input to CPU 102 via bus 106 and memory bridge 105. Visual output is provided on a pixel based display device 110 (e.g., a conventional CRT or LCD based monitor) operating under control of a graphics subsystem 112 coupled to memory bridge 105 via a bus or other communication path 113, e.g., a PCI Express (PCI-E) or Accelerated Graphics Port (AGP) link. A system disk 114 is also connected to I/O bridge 107. A switch 116 provides connections between I/O bridge 107 and other components such as a network adapter 118 and various add-in cards 120, 221. Other components (not explicitly shown), including USB or other port connections, CD drives, DVD drives, and the like, may also be connected to I/O bridge 107.

Graphics processing subsystem 112 includes a graphics processing unit (GPU) 122 and a graphics memory 124, which may be implemented, e.g., using one or more integrated circuit devices such as programmable processors, application specific integrated circuits (ASICs), and memory devices. GPU 122 may be a GPU 122 with one core or multiple cores. GPU 122 may be configured to perform various tasks related to generating pixel data from graphics data supplied by CPU 102 and/or system memory 104 via memory bridge 105 and bus 113, interacting with graphics memory 124 to store and update pixel data, and the like. For example, GPU 122 may generate pixel data from 2-D or 3-D scene data provided by various programs executing on CPU 102. GPU 122 may also store pixel data received via memory bridge 105 to graphics memory 124 with or without further processing. GPU 122 may also include a scanout module configured to deliver pixel data from graphics memory 124 to display device 110. It will be appreciated that the particular configuration and functionality of graphics processing subsystem 112 is not critical to the present invention, and a detailed description has been omitted.

CPU 102 operates as the master processor of system 100, controlling and coordinating operations of other system components. During operation of system 100, CPU 102 executes various programs that are resident in system memory 104. In one embodiment, these programs include one or more operating system (OS) programs 136, one or more graphics applications 138, and one or more graphics drivers 140 for controlling operation of GPU 122. It is to be understood that, although these programs are shown as residing in system memory 104, the invention is not limited to any particular mechanism for supplying program instructions for execution by CPU 102. For instance, at any given time some or all of the program instructions for any of these programs may be present within CPU 102 (e.g., in an on-chip instruction cache and/or various buffers and registers), in a page file or memory mapped file on system disk 114, and/or in other storage space.

Operating system programs 136 and/or graphics applications 138 may be of conventional design. A graphics application 138 may be, for instance, a video game program that generates graphics data and invokes appropriate functions of GPU 122 to transform the graphics data to pixel data. Another application 138 may generate pixel data and provide the pixel data to graphics memory 124 for display by GPU 122. It is to be understood that any number of applications that generate pixel and/or graphics data may be executing concurrently on CPU 102. Operating system programs 136 (e.g., the Graphicsal Device Interface (GDI) component of the Microsoft Windows operating system) may also generate pixel and/or graphics data to be processed by GPU 122. In some embodiments, graphics applications 138 and/or operating system programs 136 may also invoke functions of GPU 122 for general-purpose computation.

Graphics driver 140 enables communication with graphics subsystem 112, e.g., with GPU 122. Graphics driver 140 advantageously implements one or more standard kernel-mode driver interfaces such as Microsoft D3D. OS programs 136 advantageously include a run-time component that provides a kernel-mode graphics driver interface via which graphics application 138 communicates with a kernel-mode graphics driver 140. Thus, by invoking appropriate function calls, operating system programs 136 and/or graphics applications 138 can instruct graphics driver 140 to transfer geometry data or pixel data to graphics processing subsystem 112, to control rendering and/or scanout operations of GPU 122, and so on. The specific commands and/or data transmitted to graphics processing subsystem 112 by graphics driver 140 in response to a function call may vary depending on the implementation of graphics subsystem 112, and graphics driver 140 may also transmit commands and/or data implementing additional functionality (e.g., special visual effects) not controlled by operating system programs 136 or applications 138.

It will be appreciated that the system shown herein is illustrative and that variations and modifications are possible. The bus topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, graphics subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 221 connect directly to I/O bridge 107.

The connection of graphics subsystem 112 to the rest of system 100 may also be varied. In some embodiments, graphics system 112 is implemented as an add-in card that can be inserted into an expansion slot of system 100. In other embodiments, graphics subsystem 112 includes a GPU that is integrated on a single chip with a bus bridge, such as memory bridge 105 or I/O bridge 107. Graphics subsystem 112 may include any amount of dedicated graphics memory, including no dedicated memory, and may use dedicated graphics memory and system memory in any combination. Further, any number of GPUs may be included in graphics subsystem 112, e.g., by including multiple GPUs on a single graphics card or by connecting multiple graphics cards to bus 113.

### Flow Process

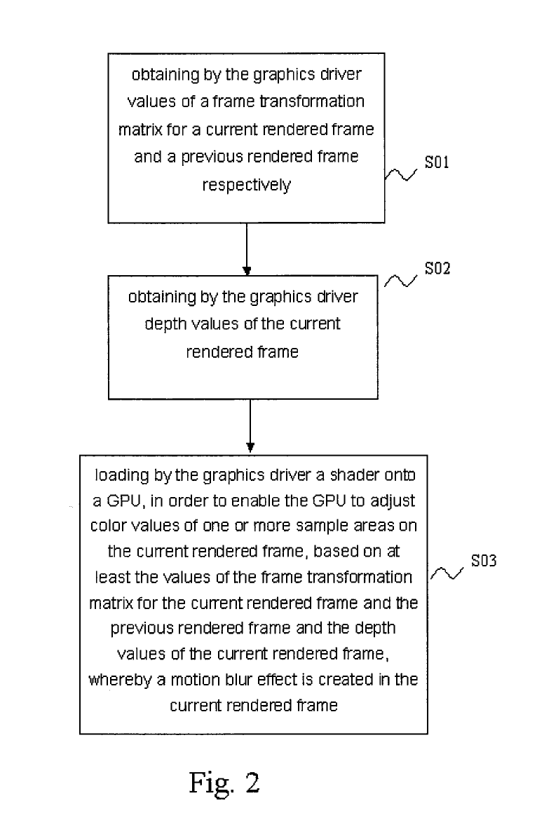

FIG. 2 is a flow diagram of a method for approximating motion blur in a rendered frame from within the Graphics driver 140 according to an embodiment of the present invention. The method may be applied to the computer system 100 as shown in FIG. 1. In particular, the method may be executed by the central processing unit 102 running a Graphics driver 140 in cooperation with the graphics processing unit 122. In short, the method shown in FIG. 2 is to create or approximate a motion blur effect in a rendered frame, as further described below.

The following description should be referred in connection with FIG. 1 and FIG. 2.

Step S01: Graphics driver 140 obtains values of a frame transformation matrix for a current rendered frame and a previous rendered frame respectively. In an embodiment, the Graphics driver 140 identities the frame transformation matrix in a constant value buffer maintained by the graphics application 138. Because a display device is designed to present 2-dimentional pictures to the user, the data or values of frame transformation matrix are required in frame rendering, where object data described in 3-dimentional coordinates supplied from the graphics application 138 are converted into 2-dimensional coordinates for the need of display.

Typically a frame transformation matrix contains 16 consecutive float values or other unique bit patterns. Therefore, by scanning data stored in the constant value buffer, the Graphics driver 140 can locate the frame transformation matrix using the bit patterns mentioned above.

In addition, while the scenes or contents may change with rendered frames, values of a frame transformation matrix will be updated accordingly, and in Step S01 it is desired to obtain values of the frame transformation matrix for a current rendered frame and a previous rendered frame respectively

Step S02: Graphics driver 140 obtains depth values of the current rendered frame. A depth buffer is maintained by the graphics application 138 to store the depth values for pixels of a rendered frame, and a depth value of pixel represents a distance of the pixel from a reference plane. Please note that the graphics application 138 may maintain a number of depth buffers corresponding to different reference planes. Therefore each frame may have different depth values in several depth buffers, but it will use depth values in only one depth buffer in frame rendering.

In Step S02, Graphics driver 140 identifies the depth buffer used for rendering the current frame, and obtains depth values of the current rendered frame therefrom.

Alternatively, in Step S02, Graphics driver 140 further obtains depth values of the previous rendered frame from the depth buffer which stores the depth value used for rendering the current frame. Note that the depth buffer used for rendering the current frame is not necessarily the one used for rendering the previous rendered frame.

Alternatively, in Step S02, Graphics driver 140 further obtains color values of the current rendered frame and/or previous rendered frame. A color buffer is maintained by the graphics application 138 to store the color values for pixels of a rendered frame,

In short, for the purpose of the following steps in this embodiment, Step S02 will need to have depth values of the current rendered frame, while depth values of the previous rendered frame, color values of the current rendered frame and/or previous rendered frame, or any other values associated with rendered frame are optional to Step S02,

Step S03: Graphics driver 140 loads a shader to GPU 122, so as to enable GPU 122 to adjust color values of one or more sample areas on the current rendered frame, based on at least the values of the frame transformation matrix for the current rendered frame and the previous rendered frame (as discussed in Step S01) and the depth values of the current rendered frame (as discussed in Step S02), whereby a motion blur effect is created or approximated in the current rendered frame. Note that the present invention does not intend to limit the algorithm implemented by the shader, and any known algorithms which are appropriate for the purpose of the present invention could be applied. Moreover, depending on the algorithm applied, GPU 122, when running the shader, may need to introduce depth values of the previous rendered frame, color values of the current rendered frame and/or previous rendered frame, or any other values associated with rendered frame (i.e., alternatives in Step S02) into calculations.

### Motion Blur Effect

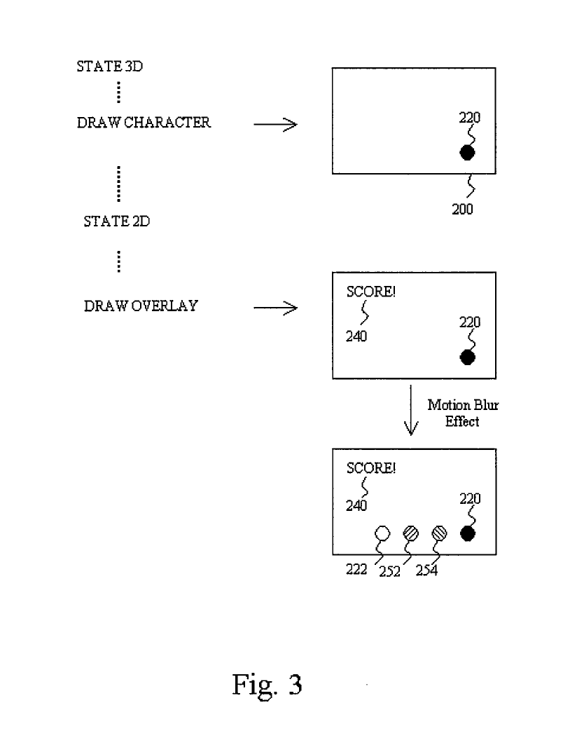

FIG. 3 shows the motion blur effect created or approximated in the current rendered frame according to an embodiment of the present invention. In general, it is preferred to have the motion blur effect on the characters, scenes, or other 3-dimentional objects, but not on 2-dimentional objects such as subtitles or text messages. For this purpose, in this embodiment, Graphics driver 140 first declares the rendering for 3-dimentional objects to GPU 122 (e.g., through a STATE 3D instruction). Then Graphics driver 140 asks GPU 122 to draw a 3-dimentional object 220 in the frame 200 (e.g., through a DRAW CHARACTER instruction). Next Graphics driver 140 declares the rendering for 2-dimentional objects to GPU 122 (e.g., through a STATE 2D instruction) and requests a 2-dimentional object 240 in the frame 200 (e.g., through a DRAW OVERLAY instruction). Accordingly, GPU 122 is able to identify the 2-dimentional object 240 which does not need the motion blur effect on it.

After the frame 200 including the 3-dimentional object 220 and the 2-dimentional object 240 is rendered, GPU 122 can run the shader loaded from Graphics driver 140 to calculate a motion blur effect for the 3-dimentional object 220 in the rendered frame 200, as discussed in Step S03.

For example, with an appropriate algorithm, it is feasible to estimate or reproject the parameters of 3-dimentional object 220 (such as location, velocity vector, or color, as denoted as numeral 222 in FIG. 3) in the previous rendered frame. With such information, GPU 122 can determine, for example, the locations and sizes of sample areas 252 and 254 on the rendered frame 220 and adjust the color values of the sample areas 252 and 254 to approximate a motion blur effect on the 3-dimentional object 220. After that, GPU 122 can present the adjusted frame 220 for display. Note that preferably, the sample areas 252 and 254 are determined by GPU 122 running the shader not to include any 2-dimentional object 240 because 2-dimentional objects such as subtitles or text messages typically need to be clearly shown and do not look good with motion blur effect.

Also note that, sample areas 252 and 254 in FIG. 3 are illustrated for exemplary purposes only, and the present invention is not limited to this example. The graphics driver 140 can set a limit on the number of the sample areas with the shader to be loaded onto GPU 122. More sample areas result to a better visual perception, but it also increases the loading and the power consumption of the GPU 122 at the same time. Hence, the present invention can regulate the number of the sample areas according to a user setting or current system operation mode (for example, a battery mode, a AC supply mode, etc.)

### Auxiliary Color Buffer

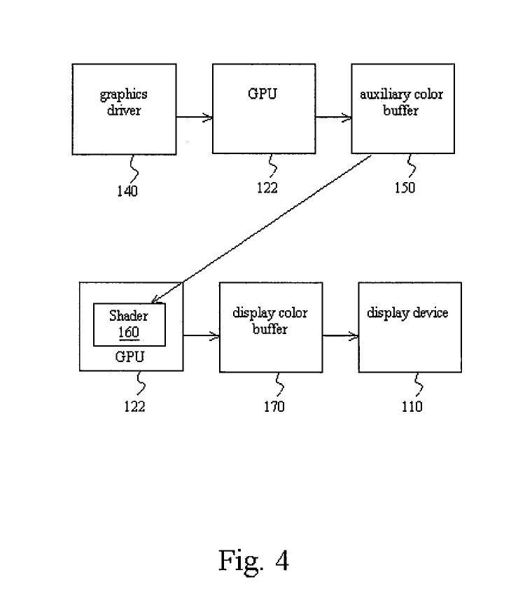

Compared to the conventional arts where a frame is sent to the display device right after being rendered by the GPU 122, one embodiment of the present invention stores the rendered frame for post-processing, instead of sending the rendered frame for display right away. For this purpose, FIG. 4 illustrates an auxiliary color buffer 150 of an embodiment according to the present invention. For example, the graphics driver 140 sends the instructions of STATE 3D, DRAW CHARACTER, STATE 2D and DRAW OVERLAY, to the GPU 122, so as to draw a frame 200 with the 3-dimentional object 220 and the 2-dimentional object 240 as shown in FIG. 3, and stores the frame 200 into the auxiliary color buffer 150.

Then, the GPU 122, running the shader 160 loaded from the graphics driver 140, fetches the frame 200 from the auxiliary color buffer 150 for post-processing, i.e., adjusting the color value of the sample areas 252 and 254 on the rendered frame 220 (as shown in FIG. 3), and then sending the adjusted rendered frame 220 to the display color buffer 170 to be presented to the display device 110.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A method for approximating motion blur in a rendered frame from within a graphics driver, comprising:
obtaining values of a frame transformation matrix for a current rendered frame and a previous rendered frame respectively;
obtaining depth values of the current rendered frame; and
loading a shader onto a GPU, in order to enable the GPU to adjust color values of one or more sample areas on the current rendered frame, based on at least the values of the frame transformation matrix for the current rendered frame and the previous rendered frame and the depth values of the current rendered frame, a motion blur effect being created in the current rendered frame.

2. The method of claim 1, wherein obtaining values further comprises identifying a frame transformation matrix in a constant value buffer of a graphics application.

3. The method of claim 1, wherein obtaining depth values further comprises identifying a depth buffer used by the current rendered frame.

4. The method of claim 3, wherein:
obtaining depth values further comprises obtaining depth values of the previous rendered frame from the identified depth buffer; and
loading the shader further comprises loading the shader in order to enable the GPU to adjust color values further based on the depth values of the previous rendered frame.

5. The method of claim 3, further comprising:
obtaining color values of the current rendered frame or the previous rendered frame,
wherein loading the shader further comprises loading the shader in order to enable the GPU to adjust color values further based on the color values of the current rendered frame and/or previous rendered frame.

6. The method of claim 1, wherein loading the shader further comprises loading the shader in order to enable the GPU to determine the one or more sample areas so that the one or more sample areas do not include a given object on the current rendered frame

7. The method of claim 6, wherein the given object is a 2D object.

8. The method of claim 1, further comprising determining a number of the one or more sample areas.

9. The method of claim 8, further comprising determining the number of sample areas according to user settings or system operation modes.

10. A computer-readable medium storing instructions, that when executed by a processor, cause the processor to approximate motion blur in a rendered frame from within a graphics driver, by performing the steps of:
obtaining values of a frame transformation matrix for a current rendered frame and a previous rendered frame respectively;
obtaining depth values of the current rendered frame; and
loading a shader onto a GPU, in order to enable the GPU to adjust color values of one or more sample areas on the current rendered frame, based on at least the values of the frame transformation matrix for the current rendered frame and the previous rendered frame and the depth values of the current rendered frame, a motion blur effect being created in the current rendered frame.

11. The computer-readable medium of claim 10, wherein obtaining values further comprises identifying a frame transformation matrix in a constant value buffer of a graphics application.

12. The computer-readable medium of claim 10, wherein obtaining depth values further comprises identifying a depth buffer used by the current rendered frame.

13. The computer-readable medium of claim 12, wherein:
obtaining depth values further comprises obtaining depth values of the previous rendered frame from the identified depth buffer; and
loading the shader further comprises loading the shader in order to enable the GPU to adjust color values further based on the depth values of the previous rendered frame.

14. The computer-readable medium of claim 12, further comprising:
obtaining color values of the current rendered frame or the previous rendered frame,
wherein loading the shader further comprises loading the shader in order to enable the GPU to adjust color values further based on the color values of the current rendered frame and/or previous rendered frame.

15. The computer-readable medium of claim 10, wherein loading the shader further comprises loading the shader in order to enable the GPU to determine the one or more sample areas so that the one or more sample areas do not include a given object on the current rendered frame

16. The computer-readable medium of claim 15, wherein the given object is a 2D object.

17. The computer-readable medium of claim 10, further comprising determining a number of the one or more sample areas.

18. The computer-readable medium of claim 17, further comprising determining the number of sample areas according to user settings or system operation modes.

19. A computer system, comprising:
a graphics processing unit (GPU);
a processor coupled to the GPU; and
a memory coupled to the processor, wherein the memory includes an application having instructions that, when executed by the processor, cause the processor to:
obtain values of a frame transformation matrix for a current rendered frame and a previous rendered frame respectively;
obtain depth values of the current rendered frame; and
load a shader onto a GPU, in order to enable the GPU to adjust color values of one or more sample areas on the current rendered frame, based on at least the values of the frame transformation matrix for the current rendered frame and the previous rendered frame and the depth values of the current rendered frame, a motion blur effect being created in the current rendered frame.

20. The computer system of claim 19, wherein:
obtaining depth values further comprises obtaining depth values of the previous rendered frame from the identified depth buffer; and
loading the shader further comprises loading the shader in order to enable the GPU to adjust color values further based on the depth values of the previous rendered frame.
